(19) United States
(12) Patent Application Publication
(10) Pub. No.: US 2022/0335373 A1
(43) Pub. Date: Oct. 20, 2022

(54) METHOD FOR INTEGRATING PRODUCTION PROCESS

(71) Applicant: Econometrix Kft., Budapest (HU)

(72) Inventor: Tamas TORKOLY, Budapest (HU)

(21) Appl. No.: 17/845,653

(22) Filed: Jun. 21, 2022

Related U.S. Application Data
(63) Continuation-in-part of application No. 16/342,728, filed on Apr. 17, 2019, now Pat. No. 11,378,940.

(30) Foreign Application Priority Data
Oct. 18, 2016 (HU) P1600584

(51) Int. Cl. G06Q 10/08; G05B 19/418

(52) U.S. Cl. CPC G06Q 10/087; G05B 19/41885; G05B 19/4185; G05B 19/41865; G05B 2219/23445

(57) ABSTRACT

Production process integrating method for the integration of multilevel production processes of a multilevel production chain comprising at least a first, a second and a third production level wherein a first production entity operating on the first production level produces a first end product which serves as a first input material for a second production entity operating on the consecutive second production level, which second production entity produces a second end product which serves as a second input material for a third production entity operating on the consecutive third production level, comprising
detecting at the second production entity, over a period of time, receipt of a plurality of the first end product produced by the first production entity operating on the first production level and serving as the first input material for the second production entity,
determining a probability index relating to a fulfilment time of a first quota consisting of a given amount of the first input material from the detected amount of received first end products over the period of time,
identifying machine and/or human activities collaborating in the production of the second end product in the second production entity, and associating production agents to the identified activities,
identifying physical parameters influencing the activity of the production agents,
measuring the identified physical parameters with sensors,
determining for each production agent a probability index relating to a fulfilment time of the activity associated with the given production agent using the measured physical parameters, and taking into consideration the probability index determined for the fulfilment time of the first quota if the first input material is used by the given production agent, —determining, by dynamic stochastic simulation, a probability index relating to the fulfilment time of a second quota consisting of a given amount of second end product to be produced on the second production level from the probability indices determined for the production agents,
providing the probability index relating to the fulfilment time of the second quota to the third production entity operating on the consecutive third production level.

### CROSS-REFERENCE TO RELATED APPLICATIONS

This application is a continuation-in-part of U.S. patent application Ser. No. 16/342,728, filed on Apr. 17, 2019, which claims priority of Hungarian Patent Application No. P1600584, filed on Oct. 18, 2016, each of which is incorporated herein in its entirety.

### TECHNICAL FIELD

The object of the invention relates to a production process integrating method for the integration of multilevel production processes in which the end product produced by a production entity operating on a lower production level serves as input material for a production entity operating on a consecutive higher production level.

### BACKGROUND

It is common for industrial production to take place on several production levels. In such cases the production entities operating on the individual production levels (such as factories) organise themselves into supply chains. However, the IT systems used for planning and monitoring are deficient, due to this the flow of information in international supply chains is inadequate. As a result of this, huge demand fluctuations are created at higher supplier levels. This results in three sources of loss for the members of the chain:
the accumulation of a significant amount of inventory that may be idle,
the continual re-planning of production, and the resulting production of batches of non-optimal size,
significant unused production capacities.

The objective of the invention is to overcome the above problems. The objective of the invention is especially the inter-company, horizontal and vertical integration of fragmented production capacities.

### SUMMARY

It was recognised by the inventor that if the separate production entities are organised into a unified virtual production capacity the problems outlined can be solved in a framework system, which may revolutionise supply chain management. It was also recognised that the cornerstone of this is the estimation of the fulfilment time of the end products produced on the individual production levels, and the providing of the obtained probability values to the next higher production level, where the end product serves as input material. It was further recognised by the inventor that in certain cases some of the production entities in a production chain are unable to obtain and provide probability values of their end products to the next higher production level where such end product is used as input material. It was recognised by the inventor that in such cases it is also possible to determine the fulfilment time of the end products from detecting the receipt of the end products at the next higher production level.

Accordingly, the present invention relates to a production process integrating method for the integration of multilevel production processes of a multilevel production chain comprising at least a first, a second and a third production level wherein a first production entity operating on the first production level produces a first end product which serves as a first input material for a second production entity operating on the consecutive second production level, which second production entity produces a second end product which serves as a second input material for a third production entity operating on the consecutive third production level, comprising:
detecting at the second production entity, over a period of time, receipt of a plurality of the first end product produced by the first production entity operating on the first production level and serving as the first input material for the second production entity,
determining a probability index relating to a fulfilment time of a first quota consisting of a given amount of the first input material from the detected amount of received first end products over the period of time,
identifying machine and/or human activities collaborating in the production of the second end product in the second production entity, and associating production agents to the identified activities,
identifying physical parameters influencing the activity of the production agents,
measuring the identified physical parameters with sensors,
determining for each production agent a probability index relating to a fulfilment time of the activity associated with the given production agent using the measured physical parameters, and taking into consideration the probability index determined for the fulfilment time of the first quota if the first input material is used by the given production agent, —determining, by dynamic stochastic simulation, a probability index relating to the fulfilment time of a second quota consisting of a given amount of second end product to be produced on the second production level from the probability indices determined for the production agents,
providing the probability index relating to the fulfilment time of the second quota to the third production entity operating on the consecutive third production level. According to an exemplary embodiment, the plurality of first end products are provided with a plurality of radio frequency labels, and the method comprises providing a radio frequency label detector at the second production entity and detecting receipt of the plurality of first end products by detecting the plurality of radio frequency labels with the radio frequency label detector.

The production levels are numbered in reverse order, in other words the end product sold to the consumers is produced by production level 0. The one or more input materials of the level 0 end product are supplied by production level 1, in other words the end product of production level 1 serves as input material on production level 0. Similarly, production level 2 is the supplier of production level 1, and supplies one or more input materials for production level 1. The number of production levels may be expanded downwards as required, in other words further suppliers may join the supply chain, for example, a production level 3 may join under production level 2.

A production entity may be, for example, a factory or other production/assembly plant.

For example, the noncumulative probability distribution function (also commonly called the probability density function), or cumulative probability distribution function of the fulfilment time, as probability variable, may be used as the probability index.

Further advantageous embodiments of the invention are defined in the attached dependent claims.

Further details of the invention will be apparent from the accompanying figures and exemplary embodiments.

### BRIEF DESCRIPTION OF THE DRAWINGS

FIG. 1 is a block diagram of an exemplary production entity using the method according to the invention,

FIG. 2a is a block diagram illustrating the parameters of the determination of the probability index relating to the fulfilment time of the activity of a production agent according to an exemplary embodiment,

FIG. 2b is a block diagram illustrating the parameters of the determination of the probability index relating to the fulfilment time of the activity of a production agent according to another exemplary embodiment,

FIG. 3 is a diagram illustrating state transitions and conditional probability indexes taking them into account,

FIG. 4 is a block diagram of an exemplary discrete event simulation used in the method according to the invention,

FIG. 5 is a block diagram of various layers of a virtual production entity,

FIG. 6 is a block diagram illustrating the connection of virtual production entities in a multilevel production chain.

### DETAILED DESCRIPTION

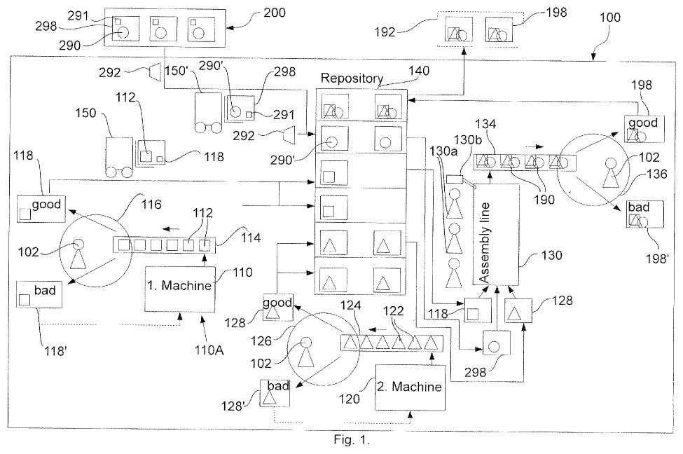

A simplified block diagram of an exemplary production entity 100 using the method according to the invention may be seen in FIG. 1. The production entity 100 may be, for example, a factory.

An exceptionally simple production process is being viewed in the interest of illustration, during which the production entity 100 manufactures a first type intermediate product 112 (such as parts) with its first machine 110, and manufactures second type intermediate products 122 (such as parts) with its second machine 120, which, using input material 290′, are assembled into an end product 190 on an assembly line 130. For the sake of simplicity, the intermediate products 112 and 122, and the end product 190 will be frequently referred to jointly as product.

The input material 290′ is an end product 290 produced by a production entity 200 (as supplier) operating on a lower production level. Naturally, in a more complex situation the production entity 100 may also use several types of input material 290′ originating from various suppliers, and the individual input materials 290′ need not be the input of assembly lines 130, they may also serve as the input of other production lines, machine lines or machines. In addition to the input material 290′ arriving from the external production entity 200, other input materials may also be used during production that are produced either by the given machine 110, or are acquired from outside the supply chain (such as fuel, plastic for injection moulding, etc.). For the purpose of differentiation these will be referred to as raw material, and raw material supply will be treated as being unobstructed, but, naturally, fluctuation of the raw material supply may also be taken into consideration on the basis of the same principle that will be presented later in connection with the input material 290′.

In the present exemplary embodiment, the end products 290 are supplied in packaging 298 containing one or more end products 290 being the input material 290′ of the receiving production entity 100. The packaging 298 or the individual end products 290 may be provided with radio frequency labels 291 which may be detected at the receiving production entity 100 by one or more radio frequency label detector 292. For example, the one or more radio frequency label detectors 292 may be installed at a gate through which the input material 290′ arrives at the premises of the production entity. Alternatively, or in addition the one or more radio frequency label detectors 292 may be installed at a gate of a repository 140 to which the input material 290′ is transported within the premises of the receiving production entity 100 before the input material 290′ is used or processed. Installing the one or more radio frequency label detectors 292 at such or similar locations may serve to automatically register the quantity of received input material 290′ as well as the time of receipt at the production entity 100.

In the case of this embodiment, the intermediate products 112 and 122 manufactured by the machines 110 and 120, as well as the end products 190 produced on the assembly line 130 get to the quality control stations 116, 126 and 136 on conveyor belts 114, 124 and 134, where the quality control of the intermediate products 112, 122, and of the end product 190 takes place via a mechanised resource (such as a camera) and/or using a human resource 102 (such as by inspection). During quality control the intermediate products 112, 122, and the end product 190 are sorted into good and bad quality products. The good quality intermediate products 112, 122 and end products 190 are preferably placed in the repository 140 until they are used. In the case of the intermediate products 112, 122 their use takes place on the assembly line 130, while in the case of the end products 190 use means supply to another production entity or to points of sale (optionally to a temporary repository).

The input materials 290′ arriving from the production entity 200 may also be placed in the repository 140, the use of which, in the present case, also takes place on the assembly line 130. In the case of this embodiment, several forklift trucks 150 are used to move products into and out of the repository 140.

The good quality intermediate products 112, 122, and end products 190 are preferably collected and supplied in boxes 118, 128, 198. Naturally, the intermediate products 112, 122, and the end products 190 may be repackaged, regrouped at any time, and even moved and stored without packaging.

The input materials 290′ also preferably arrive in packaging 298 such as boxes.

The advantage of the boxes 118, 128, 198 containing a specific amount of intermediate product 112, 122 and end product 190 is that by applying a single radio frequency (RFID—Radio Frequency Identification) label to the box 118, 128, 198, the movement of the boxes 118, 128, 198 may be tracked in a known way both on the territory of the production entity 100 and outside of it also. Naturally the intermediate products 112, 122, and the end products 190 may each have a radio frequency label attached to them. The radio frequency labels may be passive, semi-passive or active labels, and may communicate according to any desired known standard (including, for example: Bluetooth, NFC—Near field communication, ZigBee, etc.).

In the case of the present embodiment, the bad quality intermediate products 112, 122 and end products 190 are collected in separate boxes 118′, 128′, 198′. Optionally, the bad quality intermediate products 112, 122 and end products 190 may be recycled, for example, if the machines 110 and 120 are injection moulding machines, then the bad quality intermediate products 112, 122 may be ground up to serve as raw material, as the arrows with dotted lines indicate.

In the case of this embodiment the production entity 100 itself also operates as a supplier in a supply chain, and supplies a quota 192 consisting of a specific amount of end product 190 to a production entity operating one level higher, where the end products 190 serve as input material.

The method according to the invention preferably uses agent-based simulation, in the case of which production agents are allocated to the smaller units of the production process, in other words to the machine and/or human activities belonging to the production process. Obviously the smaller the units the production process is broken down to, the more refined the simulation model is, however, this makes it more computing-intensive, therefore it is preferable to specify larger activity blocks. For example, in the case of the production entity 100 shown in FIG. 1, the activity performed by the machine 110 may be treated as the first production agent 110A with which the intermediate product 112 is produced. If the machine 110 is an injection moulding tool, then the activity belonging to the first production agent 110A is injection moulding. The activity performed with the machine 120 may be treated as another production agent 120A, the transportation performed by the forklift truck 140 as a further production agent 140A, and the assembly performed on the assembly line 130 may be treated as yet another production agent 130A. A complex activity may also be performed on the assembly line 130, in which human resources 130a, and one or more machine resources 130b may also participate. In other words, the assembly as an activity, may also be broken down into part-activities, and production agents may be separately allocated to each of these. It always depends on the nature and parameters of the part-activities whether, in a given case, a complex activity may be described with a single common production agent, as in the present case with the production agent 130A.

The activity belonging to the production agents may be influenced by numerous physical parameters. From the point of view of the production entity some of these are endogenous (internal) parameters (such as the condition of the machine, the skill of the operating personnel), and some of them are exogenous (external) parameters (such as raw material, environmental parameters). It is preferable to observe the production activity modelled with the given production agent, even for a period of several months, and during this period to determine which are those physical parameters that influence the activity, especially the fulfilment time of the activity. The physical parameters are usually measured using sensors 10, but it may also happen that some of the physical parameters are obtained as data, such as from one or more databases 12. Numerous types of sensor 10 are conceivable, such as thermometer 10a, humidity meter 10b, weighing device 10c, camera 10d, biometric detector (such as a fingerprint reader, iris scanner), pressure sensor 10e, vibration sensor 10f, laser detector for die closure 10g, current consumption meter 10h, radio frequency label reader, etc.

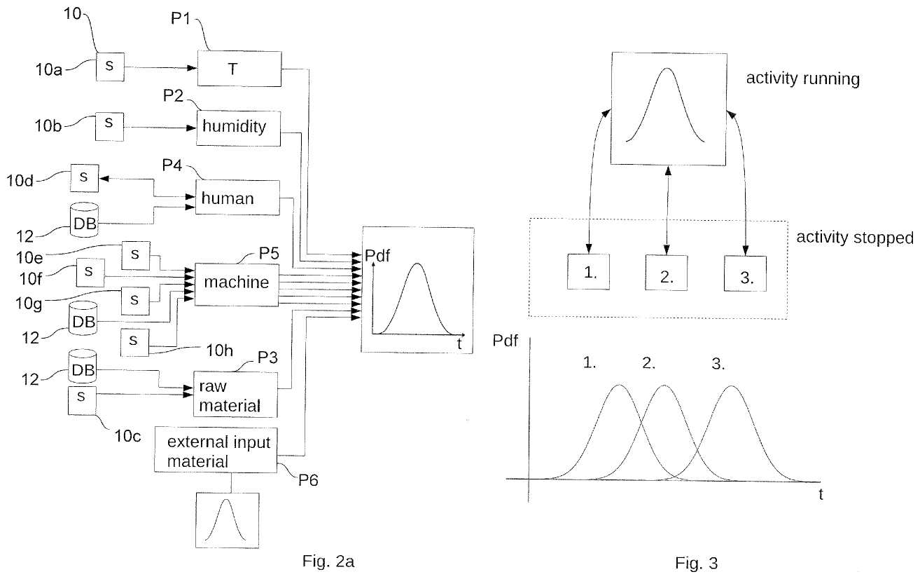

From the point of view of the production agent 110A the exogenous parameters P (FIGS. 2a and 2b) influencing the activity (injection moulding) are, for example, the following: temperature P1, humidity P2, raw material P3. Temperature P1 may be measured with a thermometer 10a, humidity P2 with a humidity meter 10b, and the raw material P3, as parameter, may be the information relating to the raw material (such as place of origin of the plastic), which may be extracted from a database 12, or it may be measurable data, such as weight, which may be measured using a weighing device 10c (such as scales).

From the point of view of the production agent 110A the endogenous parameters P influencing the activity (injection moulding) may be the following: personnel P4, machine condition P5. In the present case personnel P4, as parameter, is understood to mean that the reject rate may depend on which worker set up the machine 110 (injection mould). The parameter personnel P4 may be determined, for example, with a camera 10c, as a sensor 10, or may be extracted from a work schedule database 12. The two methods may be used to supplement each other, for example the identity of the worker who should be setting up the machine 110 at a given time is extracted from a database 12, and then a camera 10d and pattern recognition software is used to check that that worker is actually at the machine 110. Naturally other identification is conceivable, such as using a biometric sensor or with an identification code entered by the worker via a user interface.

An injection mould is also conceivable where the initial setting has no role, or every member of the personnel works in the same reliable way, in this case the parameter personnel P4 is not taken into consideration. It may also occur that the personnel influence the injection moulding (or other production activity) in other ways, in such a case the one or more parameters relating to this are described and taken into consideration. The situation is similar in the cases of the other parameters.

Machine condition P5 covers several parameters in the present case, these jointly permit a conclusion to be drawn about the machine's 110 technical condition (how reliable it is). Such parameters include, for example, the various operating parameters (injection pressure, vibration of rotating parts, die closing), as well as other parameters, such as when the machine 110 was last serviced. The latter parameter may be obtained from a database 12, for example, and the operating parameters may be measured with various sensors 10 (pressure sensor 10d, vibration sensor 10e, laser detector for die closing 10f).

The probability index relating to the fulfilment time of the activity is determined on the basis of the parameters influencing the activity (injection moulding) belonging to the given production agent 110A. The probability index relating to the fulfilment time of the quota 192 comprising a determined amount of end product 190 to be produced by the production entity 100 is determined from the probability indices determined for the individual production agents 110A, 120A, 130A, 140A.

As probability indices for example the noncumulative and cumulative probability distribution functions (or simply distribution function) of the fulfilment time, as probability variable, may be used. Usually, the distribution functions are characterised by probability density functions (PDF). The cumulative distribution function of a probability variable, evaluated at any real number x, gives the probability that the probability variable takes a value no greater than x: accordingly, this is the integral of the probability density function. Instead of distribution functions the kernels of the distribution functions may also be used as probability indices. The kernel contains those parameters from which the given probability distribution function may be produced. Another possibility, for example, is to provide the probability of fulfilment within a predetermined fulfilment time, as probability index. This is the probability value of the cumulative distribution function evaluated at the predetermined fulfilment time, which is the probability of the given process being completed within the given fulfilment time. If the fulfilment time is the fulfilment time of a quota in a supply chain, then this probability value is frequently stipulated in advance in the order for the quota, where it is referred to as a service level agreement (SLA), and refers to the reliability of the supply of the quota. It is usual in industrial supply chains to stipulate typically high SLAs of 0.9 or greater. The fulfilment time belonging to service level agreement (SLA) values specified in advance in such order contracts may also serve as a probability indicator.

The noncumulative or cumulative probability distribution function relating to the fulfilment time of the activity belonging to the production agent 110A may be determined in a known way from the parameters P influencing the activity, by using a survival model, for example.

The probability index of the fulfilment time may be corrected by monitoring the actual reject rate. This may take place automatically with sensors or on the basis of the reject number manually entered by the operating personnel. Automatic monitoring may be performed, for example, by detecting intermediate products 112, 122 when placing them in boxes 118 and/or 118′, or boxes 128 and/or 128′, and detecting end products 190 when placing them in boxes 198 and/or 198′. This may be performed, for example, by detecting the radio frequency label attached to the intermediate products 112, 122 and the end products 190.

It may happen that during injection moulding input material supplied by a supplier operating on a lower production level is used. For example, a part, as input material, is inserted into the injection mould, and the injection moulding takes place around the given component in such a way that the component becomes an integral part of the injection moulded piece. According to another example the input material is a raw or processed material the supply of which cannot be considered as being unobstructed as opposed to the supply of the raw material P3. In such cases the input material supply P6 is to be taken into consideration as a parameter, which also has probability index, such as the noncumulative probability distribution function of the fulfilment time (supply) of a quota of the input material to the currently examined production entity 100 as illustrated in FIG. 2a, which probability index the production entity operating on the next lower production level passes on to the production entity 100. Here, the fulfilment time may indicate the time when the input material is actually supplied to (e.g. shipped to) the production entity 100 which will be using the input material. If shipping of the input material cannot be regarded as being unobstructed the shipping entity can be regarded as a further production entity operating on a further production level interposed between the production level of the production entity producing the input material and the production level of the production entity 100 using the input material. Alternatively, shipping may be part of the activities of the production entity producing the input material, in which case the probability indices associated with the activities of shipping will be used to calculate the probability index of the fulfilment time of the quota by the production entity producing the input material.

According to a further exemplary embodiment illustrated in FIG. 2a, the one or more production entity operating on the lower production level(s) does not calculate or transmit the probability indices relating to the fulfilment time of the input material quota (e.g. the one or more production entity is not equipped with means for determining such the probability indices). In this case, according to the present exemplary embodiment, the production entity 100 using the input material calculates the probability index of the fulfilment time (supply) of a quota consisting of a given amount of the input material.

This may be carried out by detecting at the production entity 100, over a period of time, receipt of a plurality of the input material produced by the one or more production entities operating on the lower production level(s) and by determining the probability index of the fulfilment time (receipt) of a given quota of the input material therefrom as illustrated in FIG. 2b. The period of time should be long enough to observe fluctuations in the supply. For example, if a given quota should arrive weekly, it may be necessary to monitor one or more months to be able to statistically determine the probability index of the fulfilment time of such quota. The probability index may be the noncumulative probability distribution function of the fulfilment time (receipt) of the given quota.

According to an exemplary embodiment detecting receipt of the incoming input material may be based on data obtained from a database 12, e.g. from the records of book keeping containing the dates and quantities of the received input material.

According to another exemplary embodiment the input material 290′ are provided, either separately or as packaged batches in packaging 298, with radio frequency labels 291, and the production entity 100 using the input material is provided with a sensor 10i such as the radio frequency label detector 292 for detecting the radio frequency labels when a shipment of the input material 290′ arrives at the production entity 100. For example, the sensor 10i may be placed at the gate through which the incoming shipments arrive, whereby the sensor 10i can automatically detect the number of radio frequency labels 291 (and thereby the quantity of the input material 290′) arriving through the gate and the times of detection can be logged either by the sensor 10i or by a separate IT device, such as a computer receiving the data recorded by the sensor 10i. A probability index, such as the non-cumulative probability distribution function illustrated in FIG. 2b, can then be determined in respect of the probability variable corresponding to the fulfilment time of a given quota based on the recorded times and quantities of received input material 290.

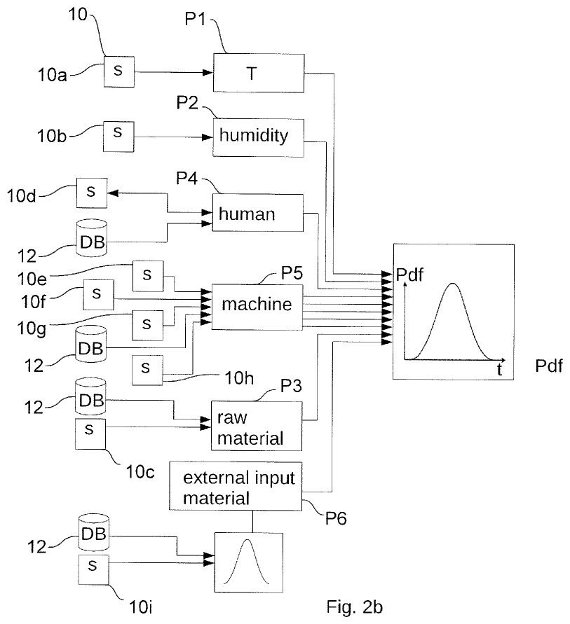

In the course of what has been described to this point it has been assumed that the given production agent is active, in other words the machine is operating, the workers are working, and the activity aimed at producing the intermediate product is being performed. However, the probability indices determined in this way, such as the probability distribution functions, lose their validity if the activity stops. This status transition may occur for various reasons, which include planned reasons (such as stoppage, rest time, planned maintenance, etc.) and unplanned reasons (such as a fault or accident, etc.). When the production agent is expected to be active once again, in other words when a status transition in the opposite direction occurs, depends on the reason of the stoppage. The fulfilment time is deferred according to this. The status transitions occurring for various reasons and the associated conditional probability distribution functions are illustrated in FIG. 3.

The probability of the occurrence of the various types of stoppage may be also modelled and built into a simulation.

In general, the actual stoppage is detected from the values measured by the sensors 10, optionally the cause may also be determined, which serves as an initial hypothesis for the expected activity restart time.

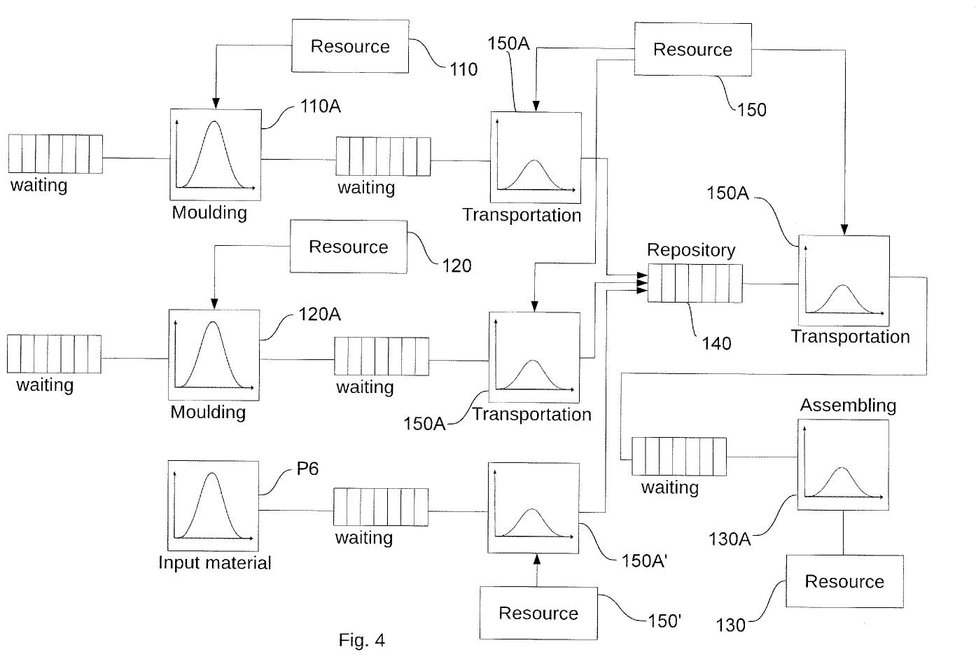

FIG. 4 illustrates a schematic block diagram of an exemplary discrete event simulation used in the method according to the invention. Stochastic dynamic simulation is preferably used in the case of the method according to the invention, in other words at discrete intervals it is determined whether a given event (such as stoppage of a machine, starting of a production, an completion of an activity, etc.) will occur at a given time on the basis of the probability indices presented earlier, such as noncumulative distribution functions.

The starting of the individual activities may be preceded by some degree of waiting time, which may be described, for example, with the conditional probabilities described in connection with the status transitions in the case of the stoppage of an activity. Waiting times may also occur if the individual production agents used shared resources. For example, in the case of the embodiment shown in FIG. 1, it is conceivable that the transportation from the machine 110 to the repository 140, the transportation from the machine 120, and the transportation from the repository 140 to the assembly line 130 are performed by the same fork lift truck 150. In this case production agents 150A use the fork lift truck 150 as a shared resource for the individual transportations, as schematically illustrated in FIG. 4. Only one of the production agents 150A can be active at any one time, with the activity being stopped at the other production agents 150A, as the single transportation device (fork lift truck 150) is only able to perform the transportation task of one production agent 150A at a time. In the case of the present example there is a separate fork lift truck 150′ for the transportation of the input material 290′ arriving from the external production entity 200, therefore the activity of the production agent 150′A associated with this fork lift truck 150′ does not depend on the production agents 150A modelling the other transportation. Naturally, such production entity is also conceivable where every transportation device is a shared resource.

Similarly, the injection moulding machine 110 and the injection moulding machine 120 may also coincide, in this case a common injection mould behaving as a shared resource would belong to production agent 110A and production agent 120A.

Naturally, it is also conceivable that other production is taking place in the given production entity 100, which also shares the resources indicated in FIG. 3 (machines 110, 120, fork lift trucks 150, 150′, assembly line 130, and the human and machine resources 102, 103 located there). Waiting times of this nature may be reduced with production optimisation within the given production entity, as will be discussed later on.

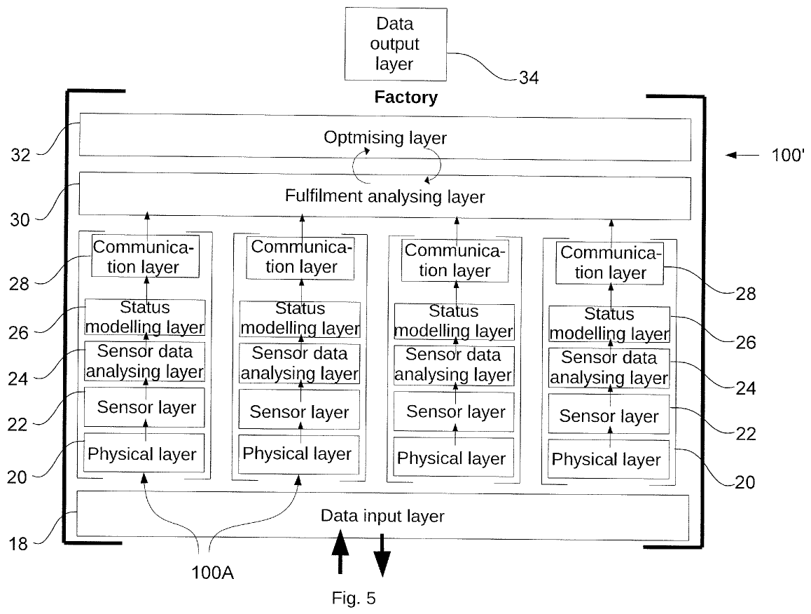

FIG. 5 depicts a block diagram of the various layers of a virtual production entity 100′. The virtual production entity 100′ may be, for example, a model of the production entity 100 illustrated in FIG. 1, and the individual layers may be logical modules, to which various hardware and/or software components belong. Naturally, a model is conceivable that is different to that presented here, as is obvious for a person skilled in the art.

The vertical columns designate virtual production agents 100A, within which the following sequential layers are differentiated: physical layer 20, sensor layer 22, sensor data analysing layer 24, status modelling layer 26, communication layer 28.

The physical layer 20 means the physical reality, such as the machine 110, the operating personnel, the raw material and/or input material obtained from other suppliers and the physical environment (temperature, humidity, pressure, etc.).

The sensor layer 22 is formed by the sensors belonging to the given production agent 100A. For example, in the case of the production agent 110A allocated to the machine 110, the sensor layer 22 is formed by the sensors 10 described in connection with FIGS. 2a and 2b.

The sensor data analysing layer 24 is logically built on the sensor layer 22, it is here that the local analysis of the data (measured parameter values) supplied by the sensors 10 are analysed, if this is possible. For example, a computer (preferably a mini PC, such as a Raspberry Pi) may be installed beside the sensors 10 that performs the local processing or pre-processing of the measured data, therefore it is not necessary to forward all of the raw measured data. In this case the pre-processed data get into the status modelling layer 26, which physically coincides with the local computer (preferably mini computer). Preferably, the evaluation of the status of the given production agent 100A takes place in the status modelling layer 26 on the basis of the pre-processed data, in other words whether the activity belonging to the production agent 100A is taking place or is stopped, and in the latter case to what cause does the status of the production agent 100A correspond. In other words, it is here that the actually occurring status transitions are determined.

The pre-processed data, or a part of the data, and the data relating to the status of the production agent 100A are forwarded using the communication layer 28 to the fulfilment analysing layer 30, which is a program or group of programs running on a central computer. The central computer is preferably a server that belongs to the given production entity 100, or it may even be a common central device of the production entities implementing the method according to the invention. The fulfilment analysing layer 30 does not necessarily run on a computer, the computing capacity may also be provided by computers (servers) in the cloud. For the sake of simplicity hereinafter reference will also be made to the sum total of the computers in the cloud as central computer.

The communication layer 28 is also understood to mean a wired or wireless channel that serves for forwarding the data from the local sensors 10 or optionally from the local computer to the central computer containing the fulfilment analysing layer 30.

If there is no local capacity for data processing, then the data may be forwarded directly from the sensors 10 to the central fulfilment analysing layer 30 via the communication layer 28. It may also occur that local data analysis exists, but the modelling of the status takes place in the fulfilment analysing layer 30, in this case the communication layer 28 sends the data supplied by the sensor data analysing layer 24 to fulfilment analysing layer 30.

Preferably the stochastic dynamic simulation takes place in the fulfilment analysing layer 30, on the basis of which the optimising layer 32 optimises, or schedules the production processes within the production entity 100, for example it optimises the use of shared resources between the production agents. The individual production agents 100A are continuously monitored via the sensors 10, or preferably via the monitoring of the reject rate, on the basis of which the parameters and results of the simulation may be continuously or periodically corrected in the fulfilment analysis layer 30. The empirical feedback may already be taken into account in the status modelling layer 26, for example the time of an expected stoppage may be more precisely estimated.

Other data may also be required for the stochastic dynamic simulation, which arrive from the data input layer 18. Such data may include, for example, probability indices (such as probability distribution functions, or their kernels) relating to input materials 290′ originating from a production entity 200 operating on the next lower level.

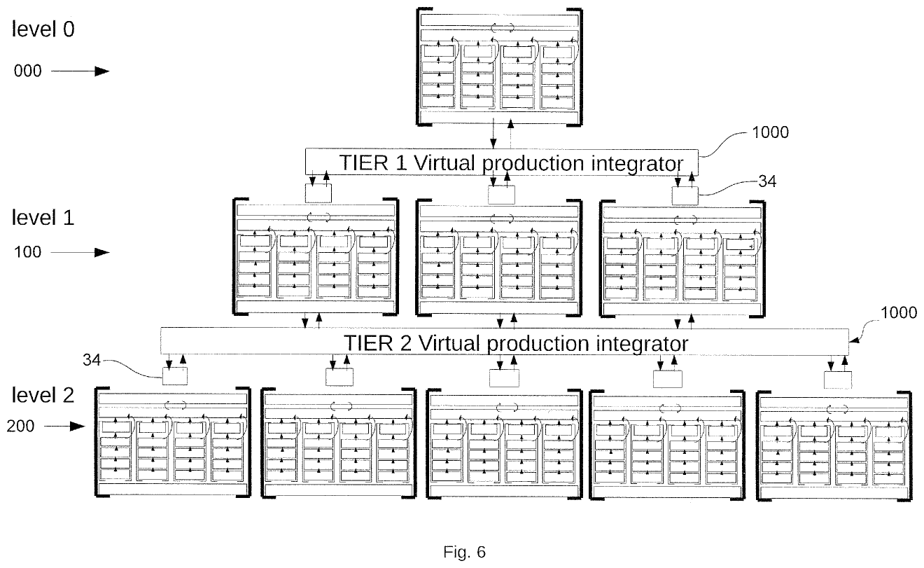

Via the stochastic dynamic simulation the fulfilment analysing layer 30 determines a probability index (such as a cumulative probability distribution function) from the probability indices determined for the production agents 100A relating to the fulfilment time of a quota 192 comprising a specific amount of end product 190 to be produced in the given production entity 100, which probability index is passed on by the data output layer 34 to the production entity 000 operating on the next higher production level, as can be seen in FIG. 6. Other data traffic may be realised between the production entities 000, 100, 200 operating on the various levels, such as requests for quotes and the sending of orders towards the lower production levels, the sending of quotes to higher production levels, then, in the case of an order being placed, the probability indices relating to the fulfilment time(s) during production. Through the continuous monitoring of production and the realistic estimation of fulfilment times, virtual production integrators 1000 may be created between the individual production levels, the function of which is to make it possible to optimise production even on the global level. For example, if the fulfilment time probability index deteriorates at a supplier (for example it is only able to guarantee a significantly longer fulfilment time as compared to the value set down in the initial SLA), then the virtual production integrator 1000 may pass on the order (or the remaining amount of the order) to other production entities operating on the same level. It should be noted that in certain cases individual production entities are able to operate on several production levels, in other words they are able to join the supply chain at more than one point depending on what input material production (or processing) they obtain orders for.

The virtual production integrators 1000 may also take other parameters into consideration in addition to fulfilment time, such as price, the SLA guaranteed by the entity providing the quote, etc.

The method according to the invention provides the following advantages.

Real-time information can be provided upwards in the supply chain (in other words to production entities operating on higher levels) on the status of all devices, processes and products participating in the production.

The method is able to take into consideration that the individual participants do not share detailed information, not even with the next level in the chain.

New participants can be linked to the production entity network provided by the method in a cost-effective way irrespective of the level of development of their IT system.

The method is able to provide realistic digital mapping of the processes on the basis of the available data.

The method is also able to predict the future probability field of the production lines (due to this the risks and expected costs of the production plan become quantifiable) using models of the process.

Taking into consideration the principle of subsidiarity it is suitable for the effective allocation of the production capacities participating in the network and for their horizontal and vertical integration.

Various modifications to the above disclosed embodiment will be apparent to a person skilled in the art without departing from the scope of protection determined by the attached claims.

1. Production process integrating method for the integration of multilevel production processes of a multilevel production chain comprising at least a first, a second and a third production level wherein a first production entity operating on the first production level produces a first end product which serves as a first input material for a second production entity operating on the consecutive second production level, which second production entity produces a second end product which serves as a second input material for a third production entity operating on the consecutive third production level, comprising
detecting at the second production entity, over a period of time, receipt of a plurality of the first end product produced by the first production entity operating on the first production level and serving as the first input material for the second production entity,
determining a probability index relating to a fulfilment time of a first quota consisting of a given amount of the first input material from the detected amount of received first end products over the period of time,
identifying machine and/or human activities collaborating in the production of the second end product in the second production entity, and associating production agents to the identified activities,
identifying physical parameters influencing the activity of the production agents,
measuring the identified physical parameters with sensors,
determining for each production agent a probability index relating to a fulfilment time of the activity associated with the given production agent using the measured physical parameters, and taking into consideration the probability index determined for the fulfilment time of the first quota if the first input material is used by the given production agent, —determining, by dynamic stochastic simulation, a probability index relating to the fulfilment time of a second quota consisting of a given amount of second end product to be produced on the second production level from the probability indices determined for the production agents,
providing the probability index relating to the fulfilment time of the second quota to the third production entity operating on the consecutive third production level.

2. The method according to claim 1, wherein the plurality of first end products are provided with a plurality of radio frequency labels, the method comprising providing a radio frequency label detector at the second production entity and detecting receipt of the plurality of first end products by detecting the plurality of radio frequency labels with the radio frequency label detector.

3. The method according to claim 1, wherein the multilevel production chain comprises a fourth production entity operating on the first production level which produces a fourth end product which serves as a fourth input material for at least one production agent (100A, 110A, 120A, 130A, 140A) of the second production entity, and when determining the probability index relating to the fulfilment time of an activity associated with the at least one production agent (100A, 110A, 120A, 130A, 140A) taking into consideration a probability index provided by the fourth production entity relating to a fulfilment time of a fourth quota (192) consisting of a given amount of the fourth end product serving as the fourth input material for the at least one production agent (100A, 110A, 120A, 130A, 140A).

4. The method according to claim 1, wherein the probability indices are the cumulative and/or noncumulative probability distribution functions of the fulfilment times as probability variables.

5. The method according to claim 1, comprising producing an intermediate product by at least one production agent, checking the quality of the intermediate product, in the case of satisfactory quality forwarding the intermediate product for further use, in the case of unsatisfactory quality rejecting the intermediate product and correcting the probability indices relating to the fulfilment times in accordance with the reject rate.

6. The method according to claim 1, comprising determining a production status and at least one non-production status for the individual production agents, and determining a probability index relating to the time of return from the at least one non-production status to the production status, and taking the probability index relating to the time of return to production status into consideration during the stochastic dynamic simulation.

7. The method according to claim 1, comprising determining during trial production dependence of the probability indices relating to the fulfilment time of the activity associated with the given production agent on the measured physical parameters, and monitoring the initially determined dependence of the probability indices on the physical parameters during production and correcting it in case of deviation.

8. The method according to claim 1, wherein in the case of a predetermined deterioration of the probability index relating to the fulfilment time of the quota (192), producing the quota (192) by another production entity (100, 200) operating on the given production level.

9. The method according to claim 1, wherein in the step of determining the probability index relating to the fulfilment time of the activity associated with each production agent (100A, 110A, 120A, 130A, 140A), using data relating to personnel participating in the activity.

10. The method according to claim 1, wherein the physical parameters are selected from a group comprising temperature, pressure, humidity, vibration frequency, die closing precision, power consumption.

11. The method according to claim 1, characterised by that the sensors are selected from a group comprising thermometer, pressure sensor, humidity meter, weighing device, vibration sensor, laser detector for die closing, other laser control systems, consumption meter, radio frequency label detector, camera, biometric detector, iris scanner, fingerprint reader.

12. The method according to claim 1, characterised by providing the end products or their packaging with radio frequency labels, and tracking the movement of the end products by detecting the radio frequency labels.
